(19) United States
(12) Patent Application Publication
(10) Pub. No.: US 2026/0297476 A1
(43) Pub. Date: Oct. 1, 2026

(54) IMPROVED STRUCTURE FOR OENOLOGICAL PROCESSING

(71) Applicant: NOFORM SRL, Meolo (IT)

(72) Inventor: Bruno CROSATO, Meolo (IT)

(21) Appl. No.: 19/483,317

(22) PCT Filed: May 6, 2024
(86) PCT No.: PCT/IB2024/054383

§ 371 Date: Nov. 11, 2025

(30) Foreign Application Priority Data
May 11, 2023 (IT) 102023000009414

(51) Int. Cl. C12G 1/00

(52) U.S. Cl. CPC C12G 1/005

(57) ABSTRACT

To enable or improve mobility in a winery during operations of oenological-processing, a raised platform is provided which is located nearby of a tank and comprises a walkable (preferably flat) surface on which a person can walk, and guiding means adapted to guide a movable oenological-processing machine.

The present invention refers to an improved structure for oenological processing. The state of the art of known movable fulling systems, taken here as an example, is illustrated in WO2017145123A1 and EP2060624, which describe movable fulling machines on guides applied to the top of one or more fermentation tanks. The more traditional movable fulling machines are coupled to structures fixed to the ceiling and/or supported by support columns on the ground. The vertical movement of the fulling plate usually relies on an actuator controlled by the operator, who must however precisely control the horizontal position of the fulling plate to pass from tank to tank or center the relative hatch.

To facilitate activities in the winery it is also known to build raised platforms around or above the tanks, placed at various heights and often connected by stairs. However, these platforms do not guarantee optimal mobility for workers, especially during the loading of the vegetable product and fulling operations, and can be improved.

The main object of the invention is to improve the present state of the art.

Another object of the invention is to allow or improve mobility in a winery during winemaking operations.

These and other objects are achieved by what is reported in the attached claims; advantageous technical features are defined in the dependent claims.

One aspect of the invention concerns a raised platform that is placed in proximity to a tank and comprises:
a walkable (preferably flat) surface on which a person can walk, and
guiding means adapted to guide a movable oenological-processing machine.

Another aspect of the invention concerns a method for installing guiding means adapted to guide a movable oenological-processing machine up to an upper opening of a tank (or in any case close to such opening), with the step of integrating guiding means on a raised platform located near the tank. Such raised platform is provided with a walkable (preferably flat) surface on which a person can walk.

Another aspect of the invention concerns a method of producing a raised platform which is
configured to be placed in a winery near a tank, and
provided with a walkable (preferably flat) surface on which a person can walk, wherein the raised platform is provided with guiding means adapted to guide a movable oenological-processing machine.

E.g. the machine may be a machine for cap-breaking and/or transporting vegetal product (e.g. must), shucking a vegetal product, pressing a vegetal product, wetting a vegetal product, continuously loading a vegetal product (whose loading mouth may be positioned at will in correspondence with the tanks), distribution of enzymes/additives/ferments, or measuring and sampling of the vegetal product contained inside the tank.

Preferably
the machine is provided with rolling members to slide on the guiding means; and/or
the machine and the guiding means are coupled via a mechanical constraint which hinders the vertical separation between the machine and the guiding means.

A great advantage of the raised platform is to make it easier for an operator to carry out the activities to be performed inside one or more tanks from the relative upper hatch, with an optimal position, such as for example fulling and/or transporting and pouring must.

Other advantages are:
the reduction of the number of structures in the winery, thanks to the integration of the two functions of walkable surface and guide for the machine in the same support platform;
the creation of a single platform for walking and guiding optimizes both the construction and installation times, as well as the final quality of the entire product, also allowing to improve the tolerances of the components, notoriously critical in the making of guiding means;
greater safety, because the guiding means can be easily placed inside the walkable surface thereby avoiding the risk of feet crushing or tripping;
ease of installation by reducing the number of components to be mounted.

To make the most of the machine, preferably said guiding means and/or the platform have an extension, or are configured, to connect the tops of two or more tanks so that the machine can move from one to the other and/or reach an elevated point. Preferably the machine is slidingly movable on the guiding means, e.g. via a caster or wheel or skid, or one or more carriages supporting a vegetal product processing device, e.g. a lowerable fulling rod.

Preferably, for construction simplicity, the guiding means comprise one or more guides, arranged horizontally or even inclined, which may be straight and/or curved. E.g. the guiding means comprise a rail, or a pair of rails preferably equidistant from each other (but also at variable distances as long as the machine or the carriages are designed to compensate such variation of distance) and arranged horizontally, wherein the rails may be straight and/or curved.

The raised platform may generally comprise a plurality of guiding means to offer multiple horizontal travel paths for the movement of said machine on a horizontal plane.

According to various embodiments, the raised platform may
develop around and/or above one or more tanks; and/or
be placed at various heights; and/or
be connected by stairs to other raised platforms; and/or
be mechanically connected to one or more tanks or be unconstrained from—and floating with respect to—one or more tanks, and/or
be provided with floor holes or openings that allow particular processes to be carried out (for example washing of all grape processing devices), and/or
be provided with one or more washing-water collection systems, systems which may be of point type or even distributed along all or part of the platform.

The guiding means are e.g. integrated and/or recessed and/or comprised and/or installed in the walkable surface, and/or on a vertical wall or enclosure that extends vertically from and/or with respect to the walkable surface.

For mounting or supporting the platform, there are preferred embodiments, which can be used alone or in combination.

In a first embodiment, the raised platform or part of it is supported by said tank and the raised platform comprises permanent-support means for resting on said tank. The raised platform preferably comprises permanent-or non-permanent-fixing means for being fixed, in whole or in part, to said tank. More preferably (but not necessarily) said fixing and/or support means are adjustable to locally adjust the support point of the raised platform. In particular, the raised platform, all or part of it, is mounted, and preferably also fixed there, on the top and/or on a side of the tank, or on the support legs that support the tank.

In a second embodiment, the tank rests on a base plane and the raised platform, or part thereof, rests on the base plane through a support structure that extends vertically from the base plane to keep the raised platform, or said part, at a certain height. In particular, the platform comprises a support structure which rests on the base plane and from which the support structure develops vertically to keep the raised platform, or part of it, at a certain height with respect to the base plane. In particular, the platform or said part is mounted on, and preferably also fixed there to, the top of the support structure. The variant may be exploited e.g. when it is necessary to discharge all or part of the weight of the platform to the ground. The support structure may comprise e.g. columns or beams. Preferably the raised platform comprises permanent-or non-permanent-fastening means for being fixed to the support structure. More preferably said fixing means are adjustable to locally adjust the support point of the raised platform on the support structure. Or the support structure and the raised platform are a single body.

In a third embodiment, the tank is placed under a ceiling and the raised platform, or part thereof, is suspended from the ceiling. In particular the raised platform, or part thereof, is mounted underneath, and preferably also fixed there, to the lower part of a suspension structure which is attached to the ceiling and from which it extends vertically downwards to support and maintain the raised platform or said part suspended at a certain height. The suspension structure may comprise e.g. columns or beams. Preferably the raised platform comprises permanent-or non-permanent-fastening means for being fixed to said portion of the suspension structure. More preferably said fixing means are adjustable to locally adjust the suspension point of the raised platform with respect to the suspension structure. Or the suspension structure and the raised platform are a single body.

In another embodiment, the tank is placed between two walls or vertical elements (such as columns, beams, lattices) and the raised platform, or part thereof, is supported by a structure connected to such vertical elements, in particular it is supported only by a structure connected to such vertical elements.

Independently of its fixing or construction, the raised platform may be placed at different heights, according to needs and intended use, in particular:
at a height higher than or substantially equal to that of the top of one or more fermentation tanks, so as to facilitate inspection of the upper hatch of the tank from which processing is carried out, or
at a height lower than the top of one or more fermentation tanks, so as to reduce the overall height at which the operator works. More preferably, the raised platform is placed alongside one or more fermentation tanks.

In one embodiment, the raised platform may have a horizontal extension such that it encroaches upon—and overlaps with—the plan of the tank, or not.

The tanks that may be equipped with the raised platform and/or processed via the raised platform may have any geometrical shape, for example: cylindrical, truncated cone, rectangular or spherical.

To improve the operation of the platform, the guiding means are preferably associated with—and/or formed in—a collection and drainage duct for processing or washing liquids, or the platform comprises a collection and drainage duct for processing or washing liquids which is associated with-and/or obtained in-the guiding means. According to a preferred embodiment, the guiding means comprise a water collection duct (channel), e.g. installed in the walkable surface, which comprises a portion configured for guiding and preferably constraining said machine to the guiding means, in particular so as to prevent its detachment in the vertical direction. Such portion for guiding is e.g. a groove/slot or a longitudinal race. In particular, the slot is an opening of the cross-section of the duct configured both to capture and convey processing water and to form a guide for a wheel.

Another aspect of the invention concerns a structure for oenological processing, comprising:
one or more fermentation tanks,
the aforementioned raised platform according to one or each of the variants defined above, and
optionally said oenological-processing machine.

Each method aspect of the invention shares one or each of the features defined herein for the platform.

Each of the variants or embodiments defined above may be implemented alone or in combination with one or each of the others.

The platform is e.g. a boardwalk, a walkway, a gallery or a bridge spanning two or more tanks.

The walkable surface may be made in many ways or with multiple materials. For example, it may be made up of a rigid grid and/or a wooden plank and/or a continuous metal plane and/or a concrete plane coated with ceramic/resin.

Further advantages will be clear from the following description, which refers to examples of preferred embodiments of a platform, in which:

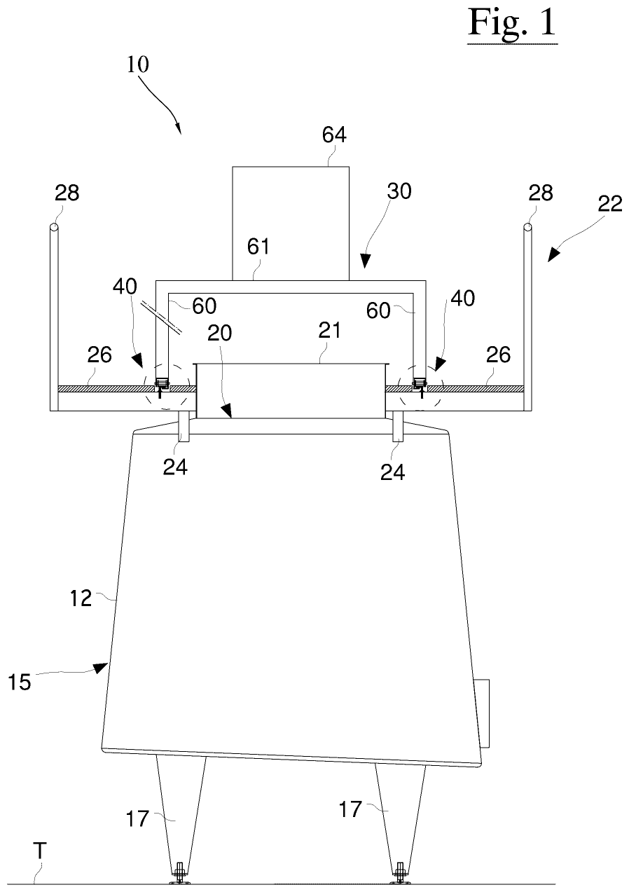

FIG. 1 shows a side view of a tank and a platform;

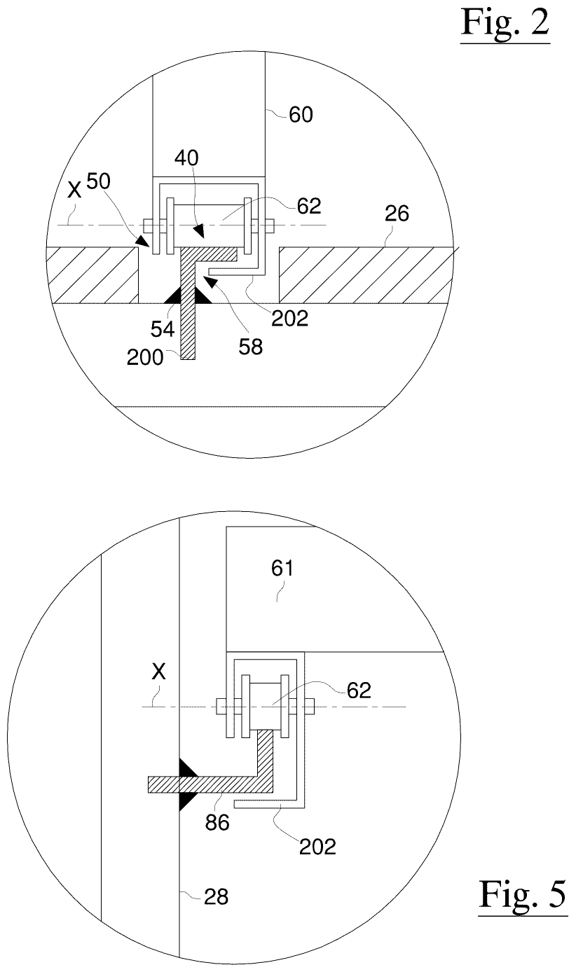

FIG. 2 shows an enlargement of the dotted circles in FIGS. 1, 3, 4, 6, 8 and 12;

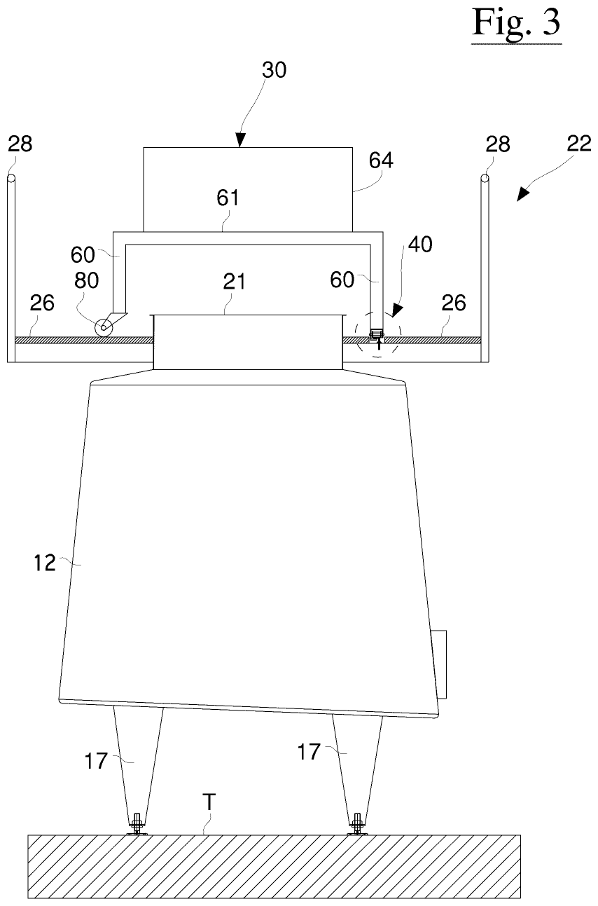

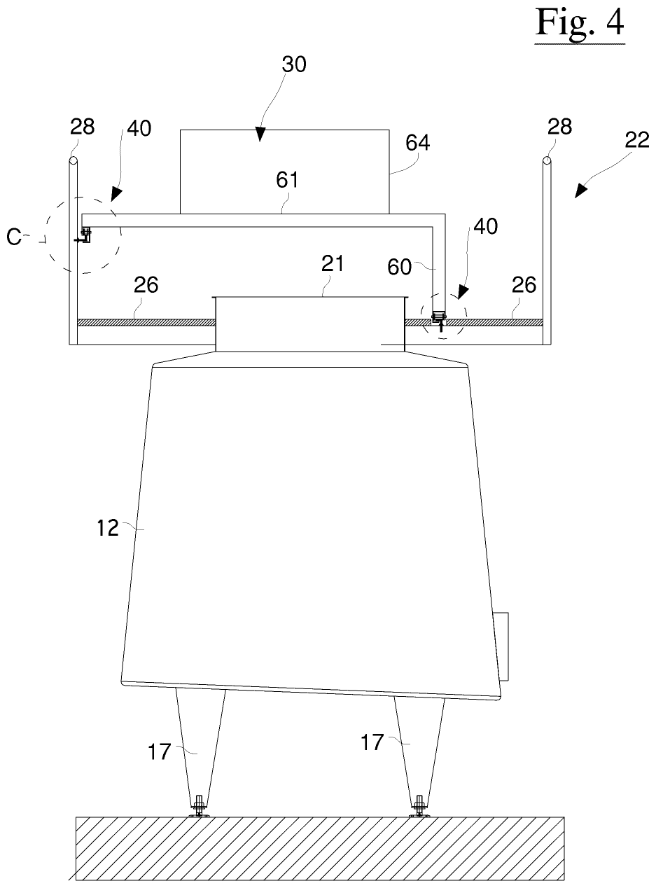

FIGS. 3 and 4 show a side view of variants of a tank and a platform;

FIG. 5 shows an enlargement of the dotted circle C in FIG. 4;

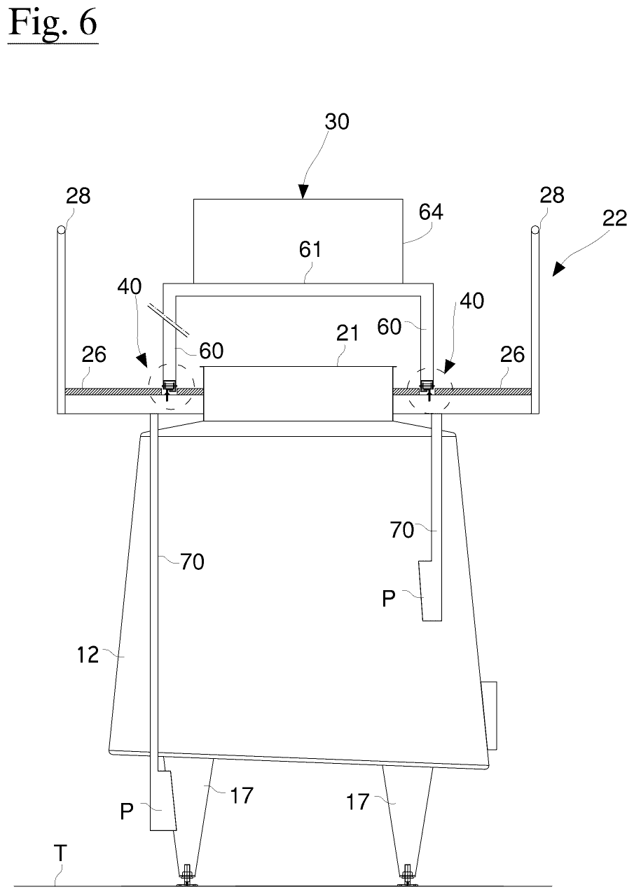

FIG. 6÷9 show a side view of variants of a tank and a platform;

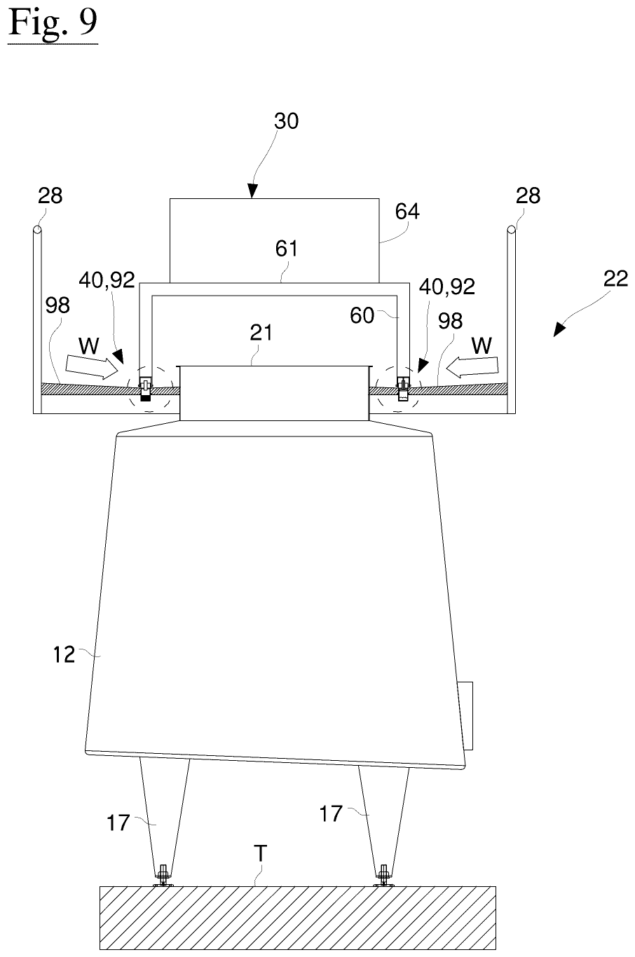

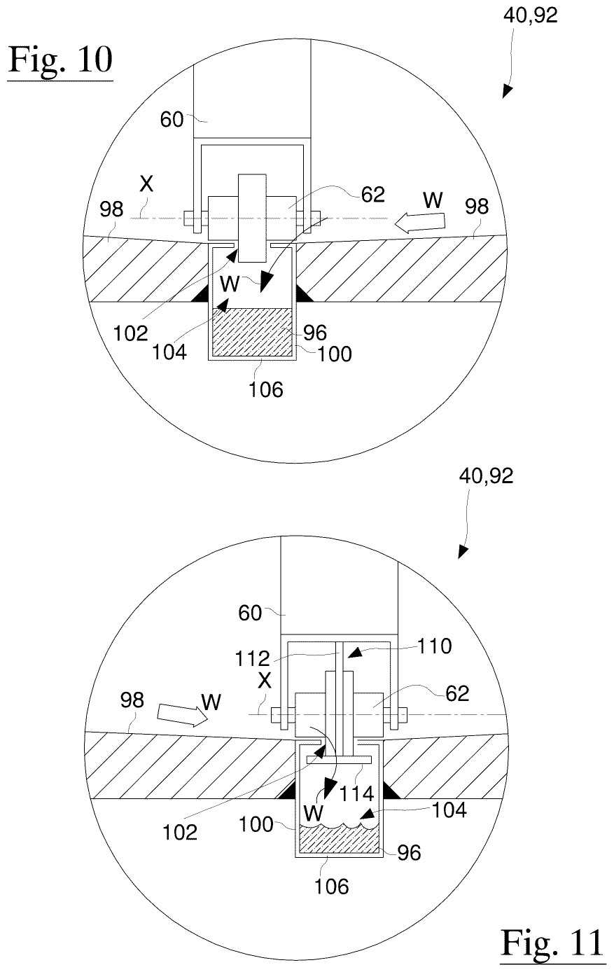

FIGS. 10 and 11 show an enlargement of the dotted circles in FIG. 9;

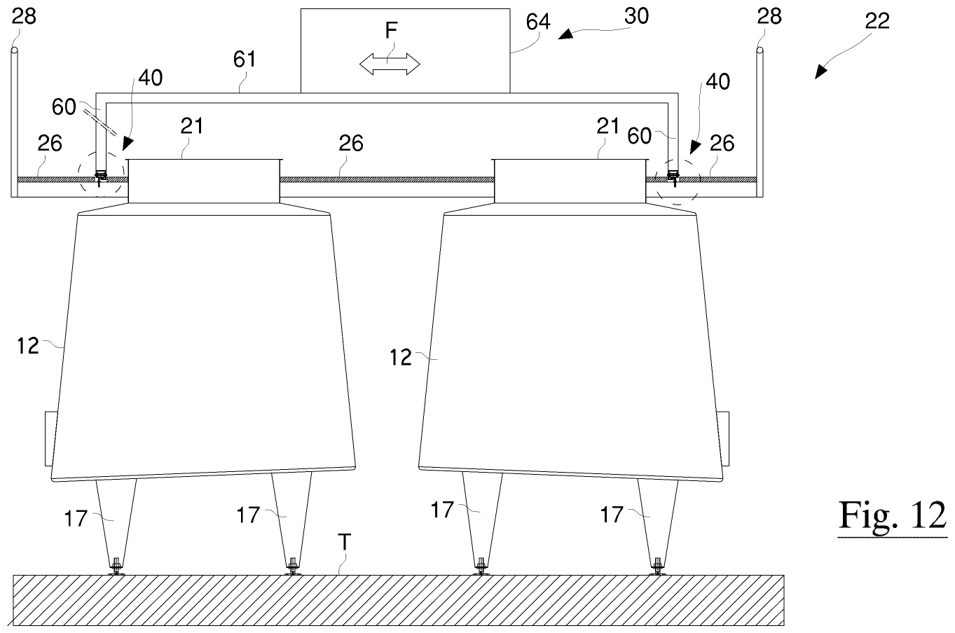

FIG. 12 shows a side view of a variant of a tank and a platform.

Equal numbers in the figures indicate equal or substantially equal parts, and the parts are described as in use.

FIG. 1 shows a winemaking system 10 provided with a known tank 12, e.g. resting on a base plane T via legs 17, and comprising a side wall 15 (delimiting the majority of its containment volume). The tank 12 has an upper part 20 which is provided with an upward opening 21 which can be opened and/or closed by a hatch.

A platform 22 raised from the base plane T is installed in proximity of the winemaking system 10. The platform 22 comprises a flat walkable surface 26, for the relocation on foot of an operator, which is preferably enclosed by vertical side walls or fences 28, for security reasons. The surface 26 is e.g. a rigid grid and/or a wooden plank and/or slabs, e.g. made of metal. The platform 22 comprises guiding means 40 (see also broken circles in the figures) for an oenological-processing machine 30, such as a fuller. The guiding means 40 are configured so that the machine 30 can be guided over the tank 12 along pre-established paths, and preferably with limited effort if the machine 30 is slidably coupled to the guiding means 40.

The machine 30 is in general configured for moving on the guiding means 40 via a cooperating sliding means 62, such as a wheel, a sled or a skid (preferably made of low-friction material), or a roller or a magnetic levitation device. The machine 30 is preferably movable on the guiding means 40 via the means 62 in the form of e.g. of skates or carriages provided with wheels that engage the rails 40 (for this case in the figures the X-axis indicates a horizontal rotation axis). Therefore an operator can easily manually push the machine 30 along the guiding means 40 while walking on the surface 26. More preferably the machine 30 comprises a carriage 61 and/or legs 60 whose lower feet are provided with the means 62 for sliding on the guiding means 40. The legs 60 or the carriage 61 preferably support a central body 64 provided with the oenological-processing means.

For all the variants described here, in general the platform 22 may have a height such as to place the surface 26 above the opening 21, approximately at the level of the opening 21, or below the opening 21 (e.g. at the level of the tank 12).

The means 40 are now described with reference to the preferred embodiments of FIGS. 2, 3 and 4, and in any case applicable to all the variants defined or described here.

In FIG. 2 the guiding means 40 are installed recessed in a cavity or groove 50 of the surface 26 (or installed on the underlying portion of the platform 22 so as to remain flush with the surface 26) not to get in the way. The fixing of the guiding means 40 to the surface 26 occurs for example by known means 54.

Preferably, the guiding means 40 comprise a rail 200 and/or a constraint member 58 to prevent the leg 60 from moving away vertically. The constraint element 58 is, for example, a longitudinal undercut which preferably extends horizontally along the entire length of the guiding means 40.

In the means 40 the constraint function is secondary; it is very advantageous if a fuller is applied on the means 40.

The guiding and constraint function in the means 40 may be performed by a single member (as represented) or by two or more members each dedicated to one function.

When it is necessary to provide a constraint system, it will preferably be implemented as shown in FIG. 2. At least one leg 60 will comprise a member 202, connected thereto and adapted to cooperate with the constraint member 58, e.g. to be placed inside the undercut and prevent the leg 60 from lifting with respect to the guiding means 40. This is advantageous for avoiding derailment of the carriage 61 and for counteracting the reaction force that develops during the sinking phase of the marc cap (fulling). In fact, during the cap-breaking phase a force is generated that is equal and opposite to the force necessary for the sinking of the marc cap.

In a preferred variant (as for example in FIG. 1), the guiding means 40 comprise at least two guiding tracks, not necessarily but preferably equidistant, and more preferably comprise two spaced apart rails, made for example like the rail 200. The two rails may be straight, curved or a combination of the two. Thus the means 40 guide the machine 30 more easily, steering it on two opposite sides.

In a different preferred variant (see FIG. 3) the guiding means 40 comprise a single guiding track for the machine 30, and preferably comprise a single rail, made for example such as the rail 200, which may be straight, curved or a combination of the two. Thus the machine 30 is guided by the means 40 on one side only. In this case the machine 30 is for example provided with rolling means 80 for sliding on the surface 26, e.g. wheels or rollers. Or the driving track alone may be made as in FIGS. 4 and/or 5.

FIGS. 4 and 5 show a different preferred embodiment for the guiding means 40, which are also or only installed on the side walls or fences 28. Preferably these guiding means 40 comprise a rail 86 fixed to and/or integrated in one or each of the walls or fences 28. The sliding means 62 is mounted on a leg 60 and/or on the carriage 61 to slide on the rail. The anti-lifting member 202 is here adapted to interfere with a lower surface of the rail 86.

Regardless of the structure of the means 40, the platform 22 may be kept raised from the base plane T in various ways, the preferred variants of which are illustrated below.

In a variant, as in FIG. 1, the platform 22 rests on the upper part 20, e.g. via supports 24 (or plinths) which preferably are also anchorings for fixing to the upper part 20. The supports 24 are configured to rest firmly without slipping on the upper part 20, and are preferably adjustable in height and/or extendable, so as to calibrate the horizontality of the platform 22.

Here the platform 22 is raised from the base plane T thanks to the tank 12 itself (the tank 12 acts as a spacer support with respect to the plane T for the platform 22). There is also the variant in which the tank 12 has a horizontal support plate, and the height adjustment system is obtained directly in the platform 22.

In the variant of FIG. 6 the platform 22 is kept raised by rigid vertical members 70 (such as for example columns or beams) which are anchored to the winemaking tank 10 at points P different from the upper part 20, for example at the side wall 15 and/or at the legs 17.

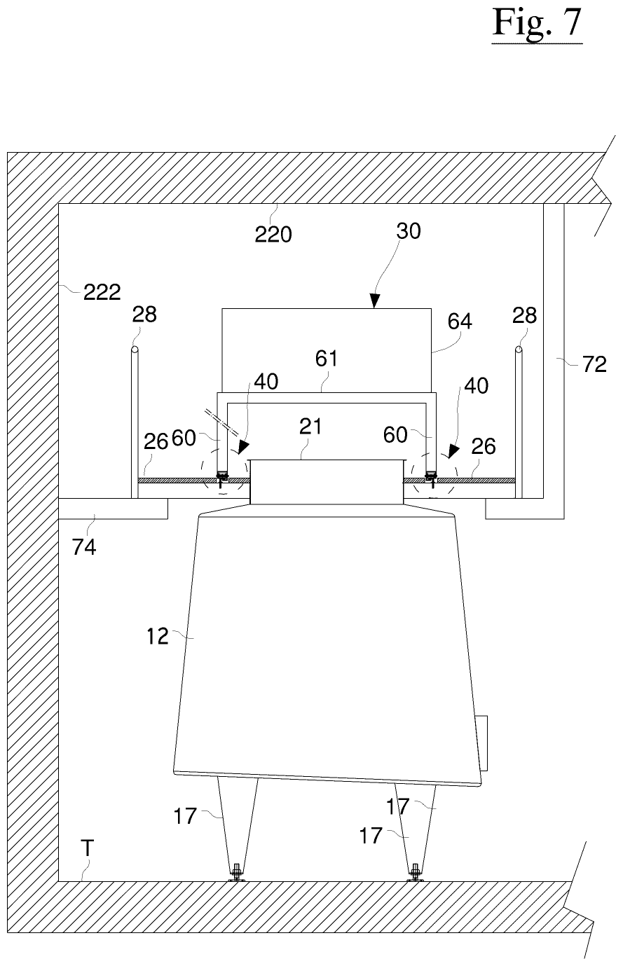

In the variant of FIG. 7 the platform 22 is kept suspended above the tank 12 without resting on the tank 12 or on the base plane T. The platform 22 is supported
by rigid vertical members 72 (such as columns or vertical beams) that are attached to a ceiling 220 of the building housing the winemaking system 10, and/or
by members 74 cantilevered from walls 222 of the building.

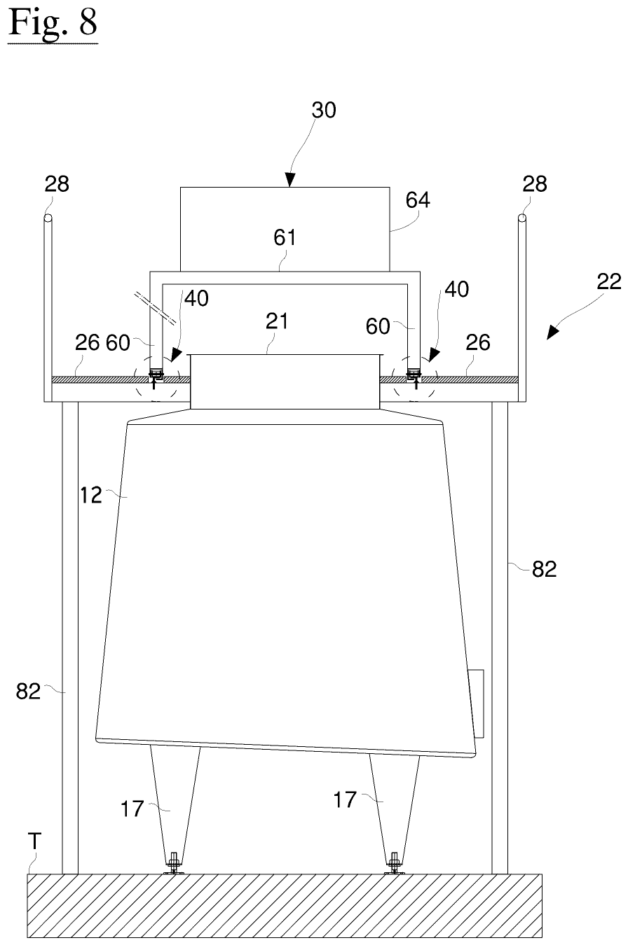

In the variant of FIG. 8, the platform 22 is kept raised by rigid vertical members 82 (such as columns or beams) which rest on the base plane T and elevate from it.

In the variants of FIG. 6÷8 the platform 22 has the same position as in FIG. 1, but not necessarily. In fact the working surface 26 may also be positioned at a lower or even higher level than the opening 21.

According to a more preferred embodiment, the guiding means 40 of all variants are improved to integrate therein the function of recovery or drainage of processing liquid 96 (e.g. water) which falls on the surface 26 (see FIGS. 9-11 where the arrows W indicate a flow of liquid). For this purpose, the guiding means 40 comprise or are constituted of means 92 for conveying a liquid, preferably in the form of a liquid collection and drainage duct. A preferred embodiment for the means 40, 92 is shown in FIGS. 10 and 11, where they comprise a conduit 100 (e.g. in the form of a sleeve or tube) which is installed in the surface 26 and delimits an internal cavity 104.

The conduit 100 is also configured as a guide for the means 62 of the machine 30. For this purpose preferably the upper part of the conduit 100 is placed flush with the surface 26, and preferably has a longitudinal slot 102 to act as a track for the means 62. In particular, the slot 102 is an opening of the cross-section of the conduit 100 towards the cavity 104. The slot 102 can thus form both a guide e.g. for a sliding wheel 62 rotatably pivoted to the foot of the leg 60, and an access for the liquid flow W towards the cavity 104, from which it will then be evacuated. Preferably, but not necessarily, the conduit 100 has a bottom 106 which is not horizontal but develops with a slope, so as to naturally transport the liquid 96.

A different coupling between the means 40 of FIG. 10 and the means 62 is shown in FIG. 11. Here a vertical constraint is obtained for the means 62 with respect to the means 40, and preferably for this purpose the foot of the leg 60 comprises a member 110 which is slidable inside the slot 102. The member 110 has shank 112 which goes through the slot 102 and an end head 114 sized to interfere with the edges of the slot 102 (e.g. the head 114 has a width wider than that of the slot 102). Thus the separation between the leg 60 and the means 40 is avoided.

It is also possible that the means 40 are mounted with a slight slope in the platform 22, to facilitate drainage.

In general, preferably the surface 26 may not be totally flat and comprise differently-sloped portions 98, to facilitate drainage. More preferably one or two portions 98 may be placed on opposite sides of the guiding means 40 and have a slope convergent towards the guiding means 40 to direct towards the latter liquid 96 present on the surface 26.

For all the variants described here, in general the surface 26 may extend only on one side of the opening 21 or it may extend completely above and/or around the opening 21. That is, the surface 26 may extend to partially or completely cover the upper part 20 (the surface 26 has then a convenient pass-through opening for access to the underlying opening 21). In a preferred variant, as in FIG. 1, the surface 26 extends around the opening 21 to completely surround it, or extends (looking from above towards the base plane T) above the upper part 20 so as to overlap the plan of the tank 12. Or the surface 26 extends around the opening 21 to partially surround it, or extends (looking from above towards the base plane T) above the upper part 20 so as to overlap and only partially cover the plan of the tank 12.

For all the variants described here, in general the platform 22 may have a larger or smaller width than the plan of the tank 12. Preferably the platform 22 and/or the guiding means 40 extend over a plurality of tanks 12, so that the machine 30 can move from one to another and serve them all.

Even if in the variants described so far the surface 26 is positioned so that the opening 21 is approximately in the middle of the surface 26 and/or the means 40, so that the machine 30 can arrive right above the opening 21, a modification is possible to the system, shown in FIG. 12. Here the platform 22 extends around two or more aligned openings 21; and the surface 26 and/or the guiding means 40 are arranged so that such openings 21 are in the middle of the surface 26 and/or the means 40. The oenological-processing means in this case will be movable horizontally along the carriage 61 (see arrow F) to reach every opening 21. The arrangement of the means 40 and/or the surface 26 in FIG. 12 may also be implemented in the variants of FIGS. 1÷11.

The various support solutions for the platform 22, and construction for the guiding means 40 and for the means 92 for conveying, can also be used in combination with each other, or in combinations other than those illustrated.

In a preferred variant, the platform 22 in plan extends only along one side of one or more aligned openings 21, and/or
extends across two rows of tanks 12, like a bridge between the two rows.

It is also possible that the means 40 are not horizontal but have an inclination such as, for example, to serve tanks of different heights, or of similar heights but placed at different heights.

1. Structure for oenological processing, comprising:
a tank;
a raised platform placed near the tank and comprising
a flat walkable surface configured so that a person can walk on it, and
guiding means for driving a movable oenological-processing machine.

2. Structure according to claim 1, wherein the guiding means comprise one or more rails, e.g. arranged horizontally.

3. Structure according to claim 1, wherein the guiding means are installed and/or recessed in the walkable surface.

4. Structure according to claim 1, wherein the platform comprises a vertical wall or fence extending vertically from and/or with respect to the walkable surface, and the guiding means are installed and/or recessed on said wall or vertical fence.

5. Structure according to claim 1, wherein the raised platform or part thereof is supported by said tank and the raised platform comprises permanent-support means for resting on said tank.

6. Structure according to claim 1, wherein the tank rests on a base plane and the raised platform comprises a support structure configured to
rest on the base plane and
develop vertically from the base plane to keep the raised platform, or part of it, at
a certain height.

7. Structure according to claim 1, wherein the tank is placed under a ceiling and the raised platform, or part thereof, is suspended from the ceiling.

8. Structure according to claim 1, wherein the tank is placed between two vertical walls or elements and the raised platform, or part thereof, is supported by a structure connected to said vertical walls or elements.

9. Structure according to claim 1, wherein the guiding means are associated with—and/or obtained in—a drain duct for a liquid.

10. Structure according to claim 1, comprising a mechanical constraint to couple the machine and the guiding means so as to hinder the vertical separation between the machine and the guiding means.

11. Method for installing guiding means adapted to guide a movable oenological-processing machine up to an upper opening of a tank, with the step of integrating the guiding means in a raised platform which is placed in proximity to the tank and is equipped with a walkable surface on which a person can walk.

12. Structure according to claim 2, wherein
the platform comprises a vertical wall or fence extending vertically from and/or with respect to the walkable surface, and
the guiding means are installed and/or recessed on said wall or vertical fence.

13. Structure according to claim 3, wherein
the platform comprises a vertical wall or fence extending vertically from and/or with respect to the walkable surface, and
the guiding means are installed and/or recessed on said wall or vertical fence.
